(19) United States
(12) Patent Application Publication
(10) Pub. No.: US 2016/0014148 A1
(43) Pub. Date: Jan. 14, 2016

(54) WEB ANOMALY DETECTION APPARATUS AND METHOD

(71) Applicants: Junghee Lee, Atlanta, GA (US); Jongman Kim, Alpharetta, GA (US); Kevone R. Hospedales, Fayetteville, GA (US)

(72) Inventors: Junghee Lee, Atlanta, GA (US); Jongman Kim, Alpharetta, GA (US); Kevone R. Hospedales, Fayetteville, GA (US)

(73) Assignee: SOTERIA SYSTEMS LLC, Alpharetta, GA (US)

(21) Appl. No.: 14/327,969

(22) Filed: Jul. 10, 2014

(51) Int. Cl. H04L 29/06

(52) U.S. Cl. CPC H04L 63/1425

(57) ABSTRACT

Provided is an apparatus and a method for detecting a web anomaly. Traditional web anomaly detection is performed by matching a signature of an attack to previously known signatures. However, such methods are unable to cope with the most recent and up-to-date attacks. According to various aspects, the proposed apparatus and method perform web anomaly detection based on web navigation activity of a user. By detecting a potential web anomaly based on navigation history, a broader range of vulnerabilities may be detected.

### BACKGROUND

1. Field

The following description relates to a method and apparatus which monitors user behavior on the web to detect a potential web anomaly.

2. Description of Related Art

A web server is continuously exposed to the public Internet. Because of such exposure, web servers are commonly targets of attacks. Existing techniques for checking vulnerabilities in a web service include web application firewall, contents filtering, and request monitoring. Most of these existing techniques, including application firewall and contents filtering, use a signature-based technology.

A signature-based detection method detects web-based attacks by comparing incoming requests against a signature database. A typical signature database is a collection of previously known attacks. However, signature-based detection schemes have a number of drawbacks because they cannot detect previously unknown attacks and they are difficult to apply to custom-developed web applications.

Unlike signature-based detection, web anomaly detection techniques such as request monitoring can be a complimentary technique to the signature-based techniques. Web anomaly detection can detect unknown attacks and be applied to custom-developed web applications. However, existing web anomaly detection schemes only monitor the input requests, which limits its coverage of vulnerabilities.

Furthermore, as its name suggests, web anomaly detection can detect abnormal behaviors, and thus, can detect unknown attacks by checking attributes of input requests. However, a major drawback of the typical web anomaly detection technique is false alarms because they are designed to alert of any suspicious behaviors which may turn out to be normal.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one aspect, there is provided a web anomaly detection apparatus including a comparator configured to compare web navigation activity of a user terminal to a web navigation map previously generated for the user terminal, and a processor configured to determine a web anomaly probability of the web navigation activity of the user terminal based on the comparison.

The web navigation activity of the user terminal may comprise a web navigation process of the user terminal from a source website to a destination website.

The comparator may be further configured to generate the web navigation map based on previous web history navigation of the user terminal gathered during a training phase.

The web navigation map may comprise a likelihood of the user terminal transitioning from a first website to each of a plurality of websites.

The processor may be configured to update a value of the web anomaly probability based on each request from the user terminal to a web server.

The web anomaly detection apparatus may further comprise an alarm configured to generate an alert to an administrator in response to the processor determining that the web anomaly probability is at or beyond a predetermined threshold.

The comparator may be configured to evaluate requests from the user terminal to a web server to determine the web navigation activity.

The web anomaly detection apparatus may further comprise a pattern matcher configured to perform pattern matching on data included in responses from a web server to the user terminal, and the processor may be further configured to determine the web anomaly probability based on the pattern matching.

The pattern matcher may be configured to detect whether sensitive information is being transmitted by the web server to the user terminal, and the processor may increase the web anomaly probability in response to the pattern matcher detecting the sensitive information being transmitted.

In another aspect, there is provided a web anomaly detection method including comparing web navigation activity of a user terminal to a web navigation map previously generated for the user terminal, and determining a web anomaly probability of the web navigation activity of the user terminal based on the comparison.

The web navigation activity of the user terminal may comprise a web navigation process of the user terminal from a source website to a destination website.

The web anomaly detection method may further comprise generating the web navigation map based on previous web history navigation of the user terminal gathered during a training phase.

The web navigation map may comprise a likelihood of the user terminal transitioning from a first website to each of a plurality of websites.

The determining the web anomaly probability may comprise updating a value of the web anomaly probability based on each request from the user terminal to a web server.

The web anomaly detection method may further comprise generating an alert to an administrator in response to determining that the web anomaly probability is at or beyond a predetermined threshold.

The comparing may comprise evaluating requests from the user terminal to a web server to determine the web navigation activity.

The web anomaly detection method may further comprise performing pattern matching on data included in responses from a web server to the user terminal, and the determining may be further performed based on the pattern matching.

The pattern matching may comprise detecting whether sensitive information is being transmitted by the web server to the user terminal, and the web anomaly probability may be increased in response to the pattern matcher detecting the sensitive information being transmitted.

Other features and aspects will be apparent from the following detailed description, the drawings, and the claims.

### BRIEF DESCRIPTION OF THE DRAWINGS

FIG. 1 is a diagram illustrating an example of a web anomaly detection apparatus.

FIG. 2 is a diagram illustrating an example of a user navigation map.

FIG. 3 is a diagram illustrating an example of a web anomaly detection function.

FIG. 4 is a diagram illustrating an example of a web anomaly detection method.

FIG. 5 is a diagram illustrating another example of a web anomaly detection method.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses and/or systems described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Examples of existing techniques for checking vulnerabilities in a web service include web application firewall and contents filtering. These techniques are based on signatures. That is, they detect attacks by detecting signatures of already known attacks. However, it can take a significant amount of time for new attacks to have their signatures determined. As a result, signature-based techniques cannot help but to lag behind state-of-the-art attacks.

Another example technique for checking vulnerabilities in a web service includes request monitoring which is a method of detecting anomalies. However, conventional request monitoring only monitors the input requests, which limits its coverage of vulnerabilities. Another major drawback of existing anomaly detection techniques is the large amount of false alarms that are generated.

According to various aspects, provided herein is a method and apparatus which may detect a web anomaly based on user navigation on the web. The proposed technique may be used alone or it may be used to complement existing techniques by monitoring the navigation process of a user and may further monitor the outbound reply messages from a web server creating the ability to detect a broader range of vulnerabilities and reducing false alarms in comparison to conventional techniques.

The web anomaly detection apparatus may monitor the navigation process of each user. For example, the user may be identified by their IP address. Whenever a request comes from the user, an anomaly score may be updated referring to a pre-computed navigation map. The navigation map may be built during a training phase in which the anomaly detection apparatus creates a navigation history of for a particular user. If the anomaly score reaches a pre-defined threshold, an alert may be sent, for example, to an administrator of the web site or web server.

According to various aspects, the web anomaly detection apparatus may also monitor the outbound reply messages of a web server using pattern matching. For example, if a reply message contains user-defined sensitive information, and the anomaly score is determined to reach a threshold, a higher-level alarm may be sent because the likelihood of an attack is greater. The sensitive information may be predefined or it may be defined by an administrator. For example, the sensitive information may include personal information such as a social security number, a phone number, mailing address, a credit card number, and the like. The format of the sensitive information may be defined by regular expressions.

As another example, paths to sensitive files may be defined as sensitive information. For example, if a download is attempted from a given path through a suspicious navigation process, a higher-level of alarm may be used as an alert. When given as a regular expression, any type of existing pattern matching algorithms can be used for detecting sensitive information.

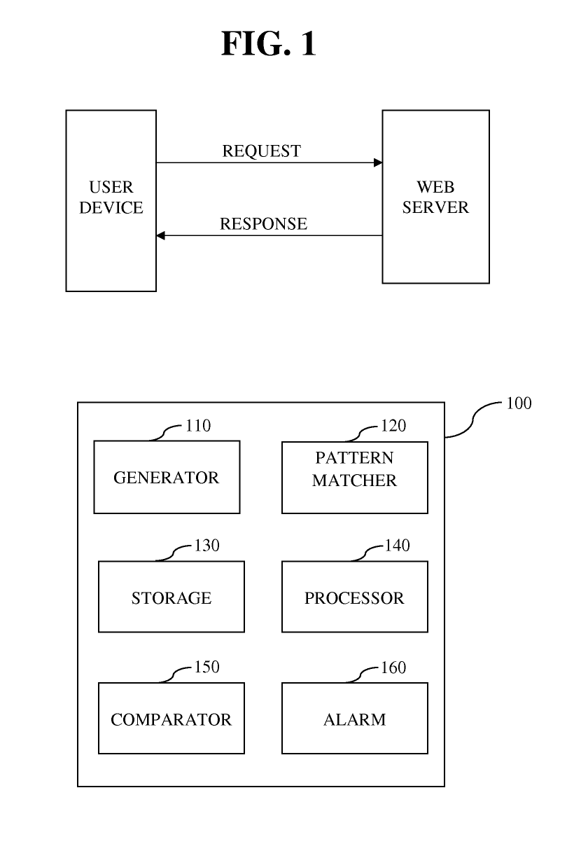

FIG. 1 illustrates an example of a web anomaly detection apparatus 100.

Referring to FIG. 1, the web anomaly detection apparatus 100 includes a generator 110, a pattern matcher 120, a storage device 130, a processor 140, a comparator 150, and an alarm 160. While illustrated as separate units in this example, it should be appreciated that one or more of the generator 110, pattern matcher 120, storage device 130, comparator 150, and the alarm 160 may be incorporated into or controlled by the processor 140.

For example, a user device may send various requests to a web server to request content such as emails, web pages, social media services (SMS), and the like. Here, the user device may be a terminal such as a computer, a mobile phone, a tablet, a server, and the like. The user device may have a browser installed therein that allows the user device to connect to and communicate with the web server. In this example, the web anomaly detection apparatus 100 may be stored on the web server, the user device, or a combination thereof.

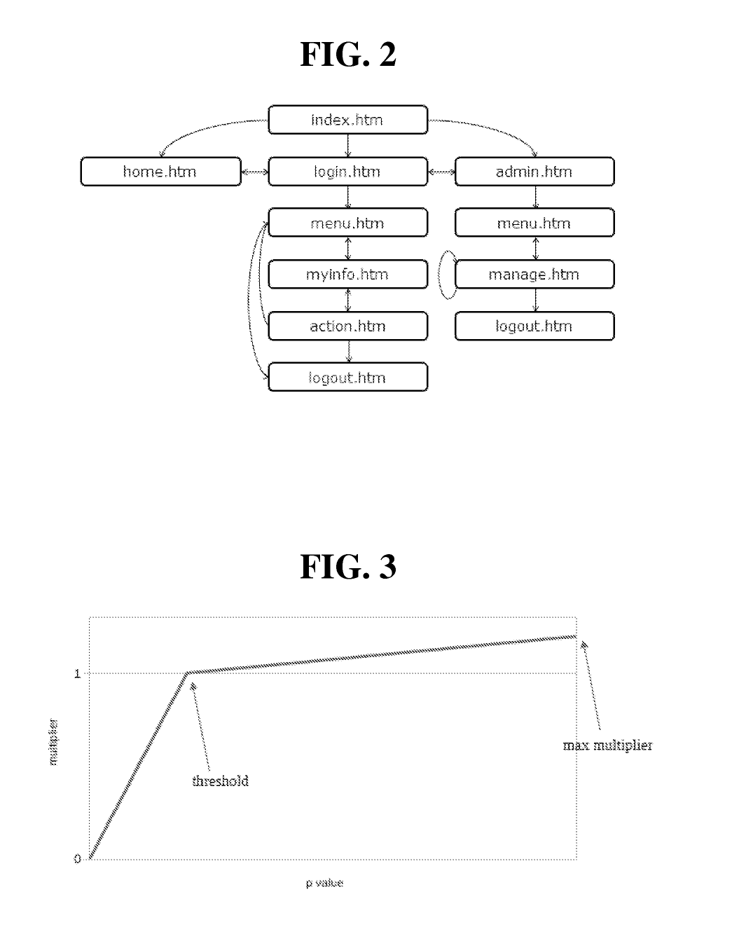

During an initial training phase, for example, of an hour, a day, or a different amount of time, the generator 110 may monitor the requests made by the user device to the web server during a user session. During this training phase, the user's behavior on the web can be monitored. For example, the web pages visited by the user may be tracked to determine a navigation map for a particular user. The navigation map may include a probability of a user transition from a source site to a plurality of destination sites. Accordingly, based on a user's previous navigation history on the web, a navigation map can be generated. An example of a navigation map is illustrated and described with respect to FIG. 2.

The navigation map may be stored in the storage device 130. For example, the storage device 130 may include read-only memory (ROM), random-access memory (RAM), flash memory, magnetic tapes, magneto-optical data storage devices, optical data storage devices, hard disks, solid-state disks, or any other non-transitory computer-readable storage medium known to one of ordinary skill in the art.

During a monitoring phase, the web anomaly detection apparatus 100 may monitor the navigation process of each user and compare the user's navigation process to the user's previous navigation history. For example, the user (or user device) may be identified by its IP address. Whenever a request comes from the user, an anomaly score may be updated by the processor 140 based on a comparison of the navigation activity of the user during a current session and the navigation map performed by the comparator 150. For example, if the anomaly score becomes below or above a pre-defined threshold indicating suspicious activity, an alert may be sent to an administrator of the web site or the web server by the alarm 160.

The web anomaly detection apparatus 100 may cover vulnerabilities that cannot be detected by conventional monitoring sessions because the apparatus may detect abnormal behavior based on navigation history. For example, broken session management, sensitive data exposure, and function access control may be detected based on the user's navigation map in comparison to the user's current navigation activity.

To further refine the anomaly detection, the pattern matcher 120 may monitor responses from the web server to the user terminal. Here, the processor 140 may use this information to make a further determination about web anomaly detection. For example, if a response contains sensitive data, which is detected by the pattern matcher 120, a higher-level alarm may be sent. For example, the sensitive information may be defined by an administrator of the web site or the web server. Examples of sensitive information include personal information such as a social security number, a phone number, a mailing address, and credit card information. By monitoring abnormal behavior as well as detecting sensitive data being leaked, the processor 140 can make a more accurate determination and prevent false alarms from being alerted.

The format of sensitive data may be given by regular expressions. In addition, paths to sensitive files can be defined by the administrator. If a download is attempted from a given path through a suspicious navigation process, a higher-level of alarm may be alerted. Once given as a regular expression, any type of existing pattern matching algorithms can be used by the pattern matcher 120 for detecting a sensitive information leak.

FIG. 2 illustrates an example of a navigation map that may be designed during a training phase. Although not shown in the figure, each arc may be weighted with a probability. As a non-limiting example, assume after visiting index.htm, 10% of users visit home.htm, 85% visit login.htm, and 5% visit admin.htm. In this example, the arcs going to home.htm, login.htm and admin.htm are weighted with 0.1, 0.85 and 0.05, respectively.

Each user session may have a particular anomaly score assigned to it which is used to determine whether or not an alarm should be triggered for that user session. For example, the current score for a user session may be stored in a score field of a latest navigation entry in a list. As an example, a new score for a user session when an entry is added may be calculated by one or more of the following:

1) The source path for this transition is looked up in the paths array.

2) The destination path is found in the corresponding list.

3) The number of occurrences of that particular source-to-destination transition is divided by the total number of transitions that occurred from that source (sum across the occurrences fields in that list). This gives a value p which represents the likelihood that the given source will transition to a given destination.

4) This p value is passed through a mathematical function that converts it to a multiplier, a value that the previous score is multiplied by to obtain the new score. An example of the mathematical function is illustrated in FIG. 3.

Referring to FIG. 3, in this example the function is designed such that if a particular transition has a probability greater than a specified threshold (adjustable value), then the previous score may be multiplied by a value greater than 1. This multiplier may be between 1 and a specified maximum, depending on the value of p. This allows the score to increase if a user's navigation becomes increasingly regular. In some examples, the score may be capped regardless of the multiplier.

If a particular transition has a probability less than the specified threshold, then the previous score may be multiplied by a value less than 1. If the score is multiplied by a value less than 1 enough times, the score will fall below a specified minimum value, indicating that the user session is behaving anomalously.

The quality of input requests during the training phase (called training inputs) will have an impact on the quality of alarms generated during the monitoring phase. For example, if the training inputs do not cover all valid navigation processes, a greater amount of false alarms may be generated. As another example, if the training inputs happen to include any attack, which is supposed to be considered abnormal, the said attack will be difficult to detect during the monitoring phase.

According to various aspects, to address these potential issues an automated tool that visits web pages following all the links provided by web pages may be used to improve the quality of alarms. By using the automated tool, a navigation map may be built without having probabilities. After building a blank navigation map, the training phase begins. During the training phase, the probabilities are computed. If an unknown link is found, which is not found by the automated tool, its probability may be assigned with a very low value. The low probability would decrease the anomaly score, which increases the chance of detecting an attack that is penetrated during the training phase.

During the monitoring phase, the history of requests may be recorded for each IP address. When a session ID is given, it may also be tagged with the IP address. If a request comes from a different IP address, but with the same session ID, a potential session fixation may be alerted. To improve quality, a name of the session ID variable may be given by the administrator of the website because it varies with implementation.

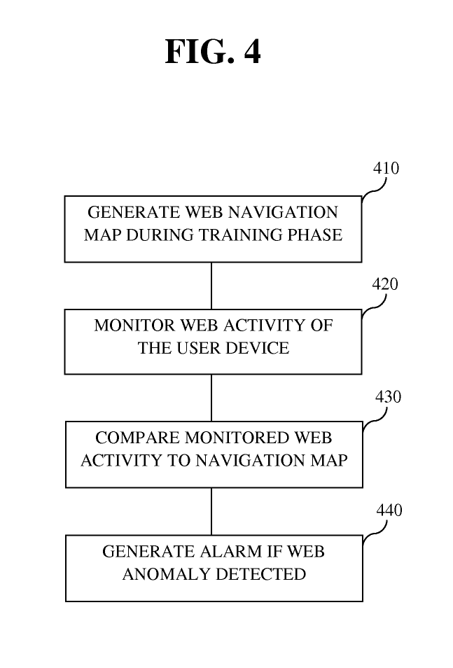

FIG. 4 illustrates an example of a web anomaly detection method.

Referring to FIG. 4, in 410 requests made by a user device to a web server are monitored and a user web navigation map is generated based on the user requests. For example, the monitoring may be done during a training session. During the training phase, the web pages visited by the user may be tracked to determine the navigation map for the particular user. As an example, the navigation map may include a probability of a user transitioning from a source site to a plurality of destination sites and the likelihood of the path taken from the source site to the destination site.

In 420, the behavior of the user device is monitored. For example, each request may be monitored or a number of requests over a predetermined period of time may be monitored. Here, the web anomaly detector may be logically located in front of a web server. Thus, the web navigation history of a particular user may be tracked.

The user's behavior (i.e. navigation history) is compared with the previously generated web navigation map in 430 to determine whether a web anomaly is occurring or has occurred. For example, whenever a request comes from the user, an anomaly score may be updated based on a comparison with the navigation map. As another example, all requests occurring within a predetermined time period may be compared to the navigation map and the anomaly score may be updated. If the anomaly score becomes reaches a pre-defined threshold indicating suspicious activity, an alarm is generated in 440.

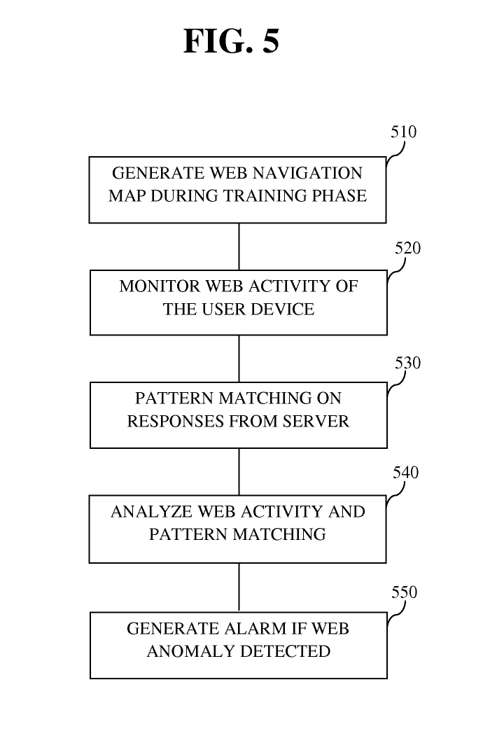

FIG. 5 illustrates another example of a web anomaly detection method. In this example, steps 510 and 520 are the same as in 410 and 420, respectively, of FIG. 4.

Referring to FIG. 5, in 530 the responses provided by the web server to the user device are monitored. For example, pattern matching may be performed on the response from the web server to further detect if sensitive information is being given to the user device. Here, the sensitive information may be predefined or may be defined by an administrator of the web site or the web server. Examples of sensitive information include personal information such as a social security number, a phone number, a mailing address, and credit card information

In 540, the users navigation history detected in 520 and the pattern matching analysis performed in 530 are analyzed to determine whether a web anomaly is occurring. By also monitoring the response made by the web server, a more detailed analysis of a potential web anomaly can be performed and false alarms can be prevented. If a web anomaly is detected, an alarm is sent in 550.

According to various aspects, there is provided a web anomaly detection apparatus and method which monitor a user's behavior during a training phase and build a user navigation map based on the sites visited. By detecting a potential web anomaly based on navigation history, a broader range of vulnerabilities can be detected. Furthermore, anomaly detection techniques generally suffer from high false alarm rate. To improve web anomaly detection and reduce false alarms, various aspects herein may also monitor the response from a web server. A higher-level alarm may be sent if abnormal behavior is detected and sensitive information is being leaked.

The methods described above can be written as a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The media may also include, alone or in combination with the software program instructions, data files, data structures, and the like. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

1. A web anomaly detection apparatus comprising:
a comparator configured to compare web navigation activity of a user terminal to a web navigation map previously generated for the user terminal; and
a processor configured to determine a web anomaly probability of the web navigation activity of the user terminal based on the comparison.

2. The web anomaly detection apparatus of claim 1, wherein the web navigation activity of the user terminal comprises a web navigation process of the user terminal from a source website to a destination website.

3. The web anomaly detection apparatus of claim 1, wherein the comparator is further configured to generate the web navigation map based on previous web history navigation of the user terminal gathered during a training phase.

4. The web anomaly detection apparatus of claim 1, wherein the web navigation map comprises a likelihood of the user terminal transitioning from a first website to each of a plurality of websites.

5. The web anomaly detection apparatus of claim 1, wherein the processor is configured to update a value of the web anomaly probability based on each request from the user terminal to a web server.

6. The web anomaly detection apparatus of claim 1, further comprising an alarm configured to generate an alert to an administrator in response to the processor determining that the web anomaly probability is at or beyond a predetermined threshold.

7. The web anomaly detection apparatus of claim 1, wherein the comparator is configured to evaluate requests from the user terminal to a web server to determine the web navigation activity.

8. The web anomaly detection apparatus of claim 1, further comprising a pattern matcher configured to perform pattern matching on data included in responses from a web server to the user terminal, and the processor is further configured to determine the web anomaly probability based on the pattern matching.

9. The web anomaly detection apparatus of claim 8, wherein the pattern matcher is configured to detect whether sensitive information is being transmitted by the web server to the user terminal, and the processor increases the web anomaly probability in response to the pattern matcher detecting the sensitive information being transmitted.

10. A web anomaly detection method comprising:
comparing web navigation activity of a user terminal to a web navigation map previously generated for the user terminal; and
determining a web anomaly probability of the web navigation activity of the user terminal based on the comparison.

11. The web anomaly detection method of claim 10, wherein the web navigation activity of the user terminal comprises a web navigation process of the user terminal from a source website to a destination website.

12. The web anomaly detection method of claim 10, further comprising generating the web navigation map based on previous web history navigation of the user terminal gathered during a training phase.

13. The web anomaly detection method of claim 10, wherein the web navigation map comprises a likelihood of the user terminal transitioning from a first website to each of a plurality of websites.

14. The web anomaly detection method of claim 10, wherein the determining the web anomaly probability comprises updating a value of the web anomaly probability based on each request from the user terminal to a web server.

15. The web anomaly detection method of claim 10, further comprising generating an alert to an administrator in response to determining that the web anomaly probability is at or beyond a predetermined threshold.

16. The web anomaly detection method of claim 10, wherein the comparing comprises evaluating requests from the user terminal to a web server to determine the web navigation activity.

17. The web anomaly detection method of claim 10, further comprising performing pattern matching on data included in responses from a web server to the user terminal, and the determining further performed based on the pattern matching.

18. The web anomaly detection method of claim 17, wherein the pattern matching comprises detecting whether sensitive information is being transmitted by the web server to the user terminal, and the web anomaly probability is increased in response to the pattern matcher detecting the sensitive information being transmitted.
